(19) United States
(12) Patent Application Publication
(10) Pub. No.: US 2008/0158104 A1
(43) Pub. Date: Jul. 3, 2008

(54) PLASMA DISPLAY DEVICE

(76) Inventor: Sung-Su Lee, Yongin-si (KR)

Correspondence Address: CHRISTIE, PARKER & HALE, LLP, PO BOX 7068, PASADENA, CA, 91109-7068, US

(21) Appl. No.: 11/940,255

(22) Filed: Nov. 14, 2007

(30) Foreign Application Priority Data
Jan. 2, 2007 (KR) 10-2007-0000111

(51) Int. Cl. G09G 3/28

(52) U.S. Cl. 345/67; 345/60

(57) ABSTRACT

A plasma display device includes: a plasma display panel including first and second electrodes and third electrodes crossing the first and second electrodes; a power supply for receiving an input voltage and generating a first voltage using the input voltage; and a first driving unit for applying an output voltage to each of the first electrodes. The output voltage falls gradually from a second voltage higher than the first voltage to the first voltage during a reset period. The first driving unit includes: a first diode having an anode coupled to each of the first electrodes; and a first switch having a first terminal coupled to a cathode of the first diode and a second terminal coupled to a first power source for supplying the first voltage. A voltage of each of the first electrodes falls to the first voltage when the first switch is in a turned-on state.

### CROSS-REFERENCE TO RELATED APPLICATION

This application claims priority to and the benefit of Korean Patent Application No. 10-2007-0000111, filed in the Korean Intellectual Property Office on Jan. 2, 2007, the entire content of which is incorporated herein by reference.

### BACKGROUND OF THE INVENTION

1. Field of the Invention

The present invention relates to a plasma display device.

2. Description of the Related Art

A plasma display device is a device that displays characters or images using plasma generated by gas discharge. Depending on its size, a plasma display panel (PDP) may include more than hundreds of thousands to millions of discharge cells arranged in a matrix shape.

In general, the plasma display device is driven during frames of time. Each frame is divided into a plurality of subfields each having a brightness weight value. Gray levels of a discharge cell in the PDP may be expressed by a combination of the brightness weight values of subfields (among the plurality of subfields) performing a display operation. Each subfield is divided into a reset period, an address period, and a sustain period. In the reset period, the states of wall charges of discharge cells are initialized. In the address period, turn-on/turn-off cells are selected. In the sustain period, a sustain discharge is performed for displaying an image on (or at) the turn-on cells.

In a conventional plasma display device, in order to select the turn-on cells in the address period, a voltage higher than a scan voltage to be applied to scan electrodes and having a level (e.g., a predetermined level) is applied to the scan electrodes at the end (or end point) of the reset period using the scan voltage. A driving circuit therefor will be described with reference to FIG. 1.

FIG. 1 is a circuit diagram showing a part of a conventional driving apparatus for a plasma display device that drives the scan electrodes.

As shown in FIG. 1, the conventional driving apparatus 10 includes a transistor YscL, a drain of which is connected to a scan electrode Y and a source of which is connected to a power source VscL supplying a voltage VscL, a Zener diode ZD1, a cathode of which is connected to the scan electrode Y, and a transistor Yfr, a drain of which is connected to the anode of the Zener diode ZD1 and a source of which is connected to the power source VscL.

At the end of the reset period, the transistor Yfr is turned on, and the transistor YscL is in a turned-off state. Then, a current path from the scan electrode Y to the power source VscL supplying the voltage VscL through the Zener diode ZD1 and the transistor Yfr is formed. With the Zener diode ZD1, a voltage to be applied to the scan electrode Y is kept higher than the voltage VscL by a level, e.g., a predetermined level, (hereinafter, referred to as ΔV).

In the address period, the transistor Yfr is turned off, and the transistor YscL is turned on. Then, a current path from the scan electrode Y to the power source VscL through the transistor YscL is formed. Accordingly, the voltage VscL is applied to the scan electrode Y.

In general, the transistors YscL and Yfr are metal-oxide semiconductor field-effect transistors (hereinafter, referred to as MOSFETs) including a body diode.

The voltage VscL is a scan voltage to be applied to the scan electrodes in order to select the turn-on cells in the address period. An address voltage is applied to address electrodes corresponding to the scan electrodes, to which the voltage VscL is applied, in synchronization with application of the voltage VscL to the scan electrodes.

Due to the address voltage to be applied to the address electrodes, the voltage of the scan electrode Y concurrently falls to a voltage lower than the voltage VscL at the moment that the address voltage is applied to the address electrodes. Then, a reverse current path from the power source VscL to the scan electrode Y through the body diode of the transistor YscL is formed. Accordingly, due to an inflow of a reverse current, a heating value of (e.g., a level of heat produced by) the transistor YscL increases.

Further, since the voltage VscL is approximately −200 V, and ΔV is approximately 25 V, the Zener diode ZD1 has a large withstand voltage of approximately 175 V. However, the use of a Zener diode having a large withstand voltage is accompanied by an increase in costs for implementing a plasma display device and an increase in power consumption.

The above information disclosed in this Background section is only for enhancement of understanding of the background of the invention and therefore it may contain information that does not form the prior art that is already known in this country to a person of ordinary skill in the art.

### SUMMARY OF THE INVENTION

An aspect of the present invention is directed to providing a plasma display device, wherein a level of heat produced by a driving circuit is reduced.

According to one exemplary embodiment, a plasma display device includes: a plasma display panel including a plurality of first electrodes, a plurality of second electrodes, and a plurality of third electrodes crossing the first and second electrodes; a power supply for receiving an input voltage and generating a first voltage using the input voltage; and a first driving unit for applying an output voltage to each of the first electrodes, wherein the output voltage falls gradually from a second voltage higher than the first voltage to the first voltage during a reset period. The first driving unit includes: a first diode having an anode coupled to each of the first electrodes; and a first switch having a first terminal coupled to a cathode of the first diode and a second terminal coupled to a first power source for supplying the first voltage. A voltage of each of the first electrodes falls to the first voltage when the first switch is in a turned-on state.

According to another exemplary embodiment of the present invention, a plasma display device includes: a plurality of first electrodes; and a first driving unit for applying a scan voltage to each of the first electrodes in an address period. The first driving unit includes: a first diode having an anode coupled to each of the first electrodes; and a first switch having a first terminal coupled to a cathode of the first diode and a second terminal coupled to a first power source for supplying the scan voltage. The first diode is adapted to hinder a current flow from the first power source to each of the first electrodes.

### BRIEF DESCRIPTION OF THE DRAWINGS

FIG. 1 is a circuit diagram showing a part of a conventional driving apparatus for a plasma display device that drives the scan electrodes.

FIG. 2 is a block diagram showing a plasma display device according to an exemplary embodiment of the present invention.

FIG. 3 is a diagram showing driving waveforms of a plasma display device according to an exemplary embodiment of the present invention.

FIG. 4 is a circuit diagram of a scan electrode driver (e.g., scan electrode driver 400 of FIG. 2) according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that a first element is “coupled” to a second element, the first element may be “directly coupled” to the second element or “electrically coupled” to the second element through one or more other elements. In addition, unless explicitly described to the contrary, the word “comprise” and variations such as “comprises” or “comprising”, will be understood to imply the inclusion of stated elements but not the exclusion of any other elements.

The term “wall charges” used herein means charges formed on a wall close to each electrode of a discharge cell (for example, a dielectric material layer). Although the wall charges do not actually touch the electrodes, the wall charges will be described as being “formed” or “accumulated” on the electrodes. The term “wall voltage” means a potential difference formed on the wall of the discharge cell by the wall charges.

A plasma display device according to an exemplary embodiment of the present invention will now be described in more detail with reference to the drawings.

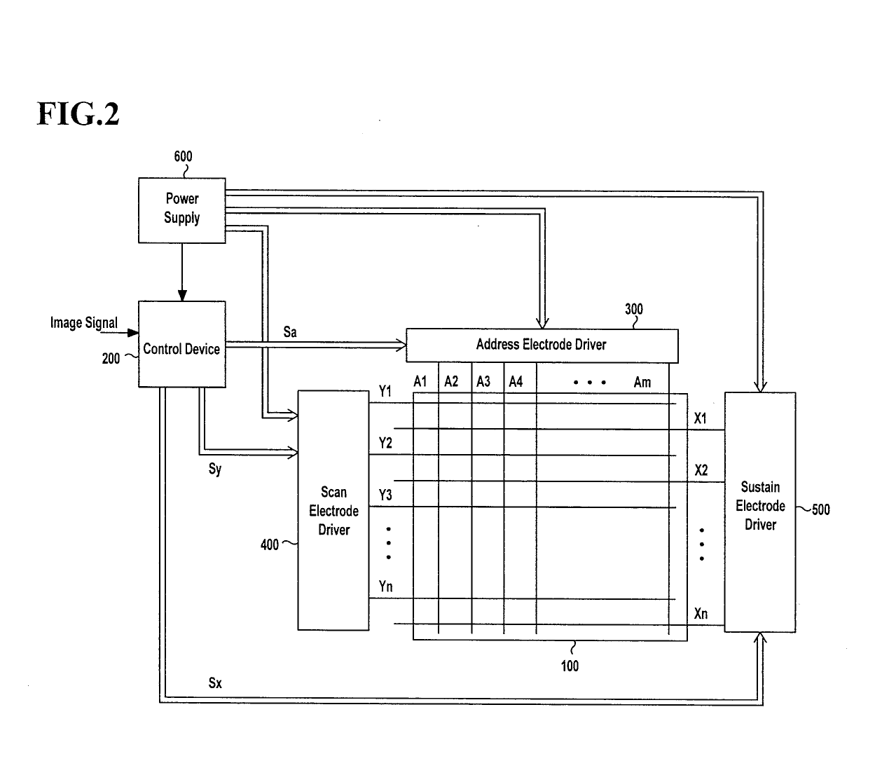

FIG. 2 is a block diagram showing a plasma display device according to an exemplary embodiment of the present invention.

As shown in FIG. 2, a plasma display device according to an exemplary embodiment of the present invention includes a plasma display panel 100, a control device 200, an address electrode driver 300, a scan electrode driver 400, a sustain electrode driver 500, and a power supply 600.

The plasma display panel 100 is provided with a plurality of address electrodes A1 to Am extending in a column direction, and a plurality of sustain electrodes X1 to Xn and scan electrodes Y1 to Yn extending in a row direction in pairs. The sustain electrodes X1 to Xn are formed to correspond to the scan electrodes Y1 to Yn. In general, the sustain electrodes X1 and Xn are commonly connected to one another at one end. The plasma display panel 100 has a substrate on which the sustain electrodes X1 to Xn and the scan electrodes Y1 to Yn are arranged and a substrate on which the address electrodes A1 to Am are arranged. The two substrates are disposed to face each other with a discharge space defined therebetween such that the scan electrodes Y1 to Yn and the address electrodes A1 to Am, and the sustain electrodes X1 to Xn and the address electrodes A1 to Am are perpendicular to each other. Here, discharge spaces at crossings of the address electrodes A1 to Am, the sustain electrodes X1 to Xn, and the scan electrodes Y1 to Yn form discharge cells. The above-described structure of the plasma display panel 100 is presented only as an example for purposes of description. For example, a panel having a different structure, to which driving waveforms described below can be applied, can also be applied to the present invention.

The control device 200 receives an external video signal and outputs an address electrode driving control signal Sa, a sustain electrode driving control signal Sx, and a scan electrode driving control signal Sy. The control device 200 drives the plasma display device by dividing each frame into a plurality of subfields. Each subfield includes a reset period, an address period, and a sustain period in a temporal operation variation manner. Further, the control device 200 generates a high scan voltage Vscan_h, which is applied to cells to be not addressed in the address period, using a DC voltage supplied from the power supply 600 and supplies the generated high scan voltage to the scan electrode driver 400 or the sustain electrode driver 500.

The address electrode driver 300 receives the address electrode driving control signal Sa from the control device 200 and applies display data signals for selecting the discharge cells to the individual address electrodes.

The scan electrode driver 400 receives the scan electrode driving control signal Sy from the control device 200 and applies a driving voltage to the scan electrodes Y.

The sustain electrode driver 500 receives the sustain electrode driving control signal Sx from the control device 200 and applies a driving voltage to the sustain electrodes X.

The power supply 600 supplies voltages required for driving the plasma display device to the control device 200 and the individual drivers 300, 400, and 500.

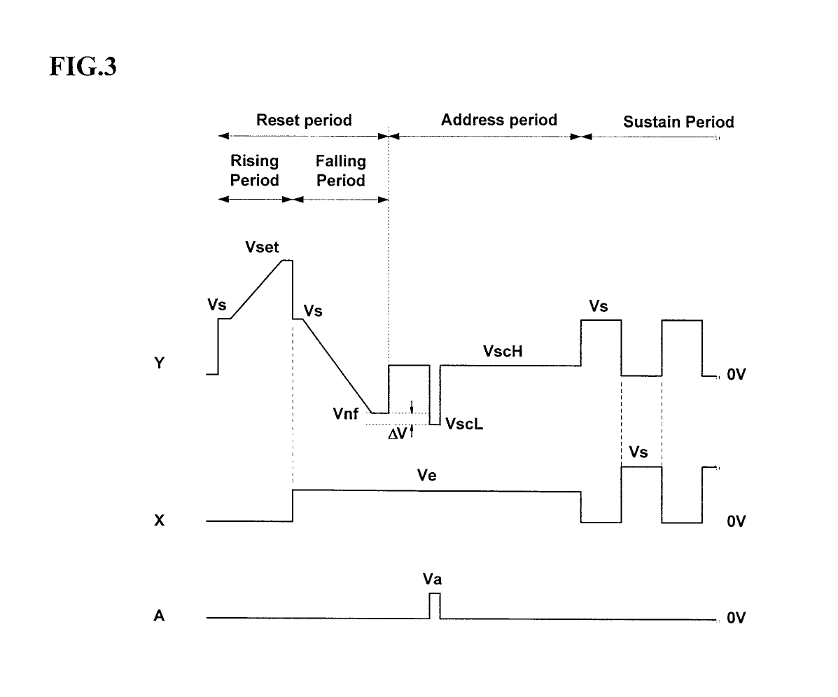

FIG. 3 is a drawing showing driving waveforms of the plasma display device according to an exemplary embodiment of the present invention.

The driving waveforms of the plasma display device shown in FIG. 3 include driving waveforms in each subfield. In the plasma display panel 100 (for example, see FIG. 2), each subfield includes a reset period, an address period, and a sustain period according to changes in voltage applied to the sustain electrode X, the scan electrode Y, and the address electrode A under the control of the control device 200 (for example, see FIG. 2).

First, the reset period will be described. The reset period includes a rising period and a falling period. In the rising period, where the address electrode A and the sustain electrode X are kept to a reference voltage (for example, 0 V in FIG. 3), a voltage of the scan electrode Y is gradually increased from a voltage Vs to a voltage Vset. The increase in voltage of the scan electrode Y causes a weak discharge between the scan electrode Y and the sustain electrode X and between the scan electrode Y and the address electrode A. As such, negative (−) wall charges are formed on the scan electrode Y, and positive (+) wall charges are formed on the sustain electrode X and the address electrode A. The sum of a wall voltage between the electrodes caused by the wall charges when the voltage of the scan electrode Y reaches the voltage Vset and an external voltage is consistent with a discharge firing voltage Vf. In the reset period, the states of all cells are initialized. Accordingly, the voltage Vset is suitably high such that discharge can occur in the cells under all (or substantially all) conditions. FIG. 3 shows the voltage of the scan electrode Y increasing and decreasing in the shape of a ramp. Alternatively, a different type of waveform that gradually increases or decreases may be applied.

In the falling period, where the address electrode A and the sustain electrode X are kept to the reference voltage and a voltage Ve, respectively, the voltage of the scan electrode Y is gradually decreased from the voltage Vs to a voltage Vnf. The decrease in voltage of the scan electrode Y causes a weak discharge between the scan electrode Y and the sustain electrode X and between the scan electrode Y and the address electrode A. As such, the negative wall charges formed on the scan electrode Y and the positive wall charges formed on the sustain electrode X in the rising period are erased. As a result, the amount of the negative wall charges of the scan electrode Y and the amount of the positive wall charges of the sustain electrode X and the address electrode A are decreased. Here, the amount of the positive wall charges of the address electrode A is decreased to an amount suitable for an address operation to be performed. In general, the magnitude of a (Vnf-Ve) voltage is set to approximately the discharge firing voltage Vf between the scan electrodes Y and the sustain electrodes X. Accordingly, a difference in wall voltage between the scan electrode Y and the sustain electrode X approximates to 0 V when the voltage of the scan electrode Y is decreased to the voltage Vnf. Cells, in which an address discharge does not occur in the address period, are prevented (or hindered) from being misfired in the sustain period.

In the reset period, the falling period has to exist in every subfield. In contrast, the existence of the rising period is determined according to a control program prescribed in the control device 200 (for example, see FIG. 2) for each subfield.

In the address period, where the voltage Ve is applied to the sustain electrodes X in order to select light-emitting cells, scan pulses having a voltage VscL (scan voltage) are sequentially applied to the plurality of scan electrodes Y. Concurrently, an address voltage Va is applied to the address electrodes A of light-emitting cells among a plurality of cells formed by the scan electrodes Y, to which the voltage VscL is applied. An address discharge occurs between the address electrode A applied with the address voltage and the scan electrode Y applied with the voltage VscL and between the scan electrode Y applied with the voltage VscL and the sustain electrode X corresponding to the scan electrode Y applied with the voltage VscL. Accordingly, positive wall charges are formed on the scan electrode Y, and negative wall charges are formed on the address electrode A and the sustain electrode X. Here, the voltage VscL is set to a level lower than the voltage Vnf by a voltage ΔV, e.g., a predetermined voltage. A voltage VscH (non-scan voltage) higher than the voltage VscL is applied to the scan electrodes Y not applied with the voltage VscL, and the reference voltage is applied to the address electrodes A of the non-selected discharge cells.

In the sustain period, sustain pulses alternately having a high level voltage (e.g., the voltage Vs in FIG. 3) and a low level voltage (e.g., 0 V in FIG. 3) are applied to the scan electrodes Y and the sustain electrode X in opposite phases. Accordingly, when the voltage Vs is applied to the scan electrode Y, 0 V is applied to the sustain electrode X. Further, when the voltage Vs is applied to the sustain electrode X, 0 V is applied to the scan electrode Y. The wall voltage between the scan electrode Y and the sustain electrode X by address discharge and the voltage Vs causes a discharge between the scan electrode Y and the sustain electrode Y. Thereafter, the process of applying the sustain pulses to the scan electrode Y and the sustain electrode X is repeated by the number of times corresponding to a brightness weight value to be displayed by the corresponding subfield.

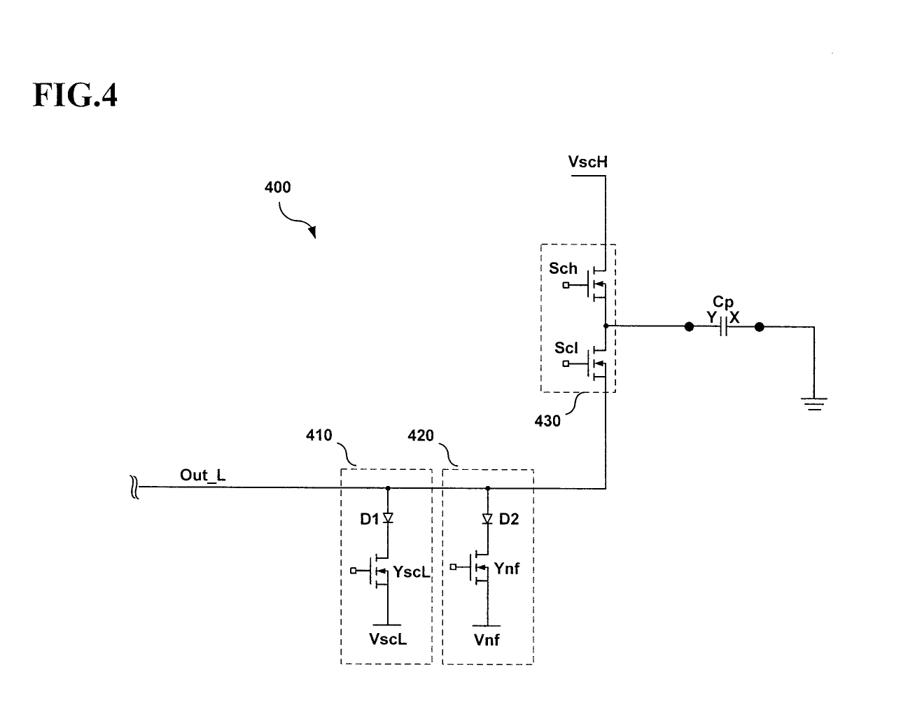

Hereinafter, a driving circuit in the scan electrode driver 400 (for example, see FIG. 2) that, of the driving waveforms shown in FIG. 3, applies a voltage VscH, a voltage VscL, and a voltage Vnf to the scan electrode Y will be described with reference to FIG. 4.

FIG. 4 is a circuit diagram showing the scan electrode driver 400 (for example, see FIG. 2) according to an exemplary embodiment of the present invention. The scan electrode driver 400 (for example, see FIG. 2) according to an exemplary embodiment of the present invention includes a plurality of driving circuits for implementing the driving waveforms of the plasma display device according to the exemplary embodiment of the present invention shown in FIG. 3. However, FIG. 4 shows only parts having relation to the main features and/or aspects of the present invention.

By way of example, while only one scan electrode Y, one sustain electrode X and one selection circuit 430 are shown in FIG. 4, one skilled in the art would recognize that the scan electrode driver 400 provides waveforms to a plurality of scan electrodes Y, each coupled to a corresponding one of selection circuits 430. Also, while the X electrode is shown as being coupled to ground, as can be seen in FIG. 2, the X electrode (which represents a plurality of X electrodes) is coupled to the sustain electrode driver 500.

As shown in FIG. 4, the scan electrode driver 400 (for example, see FIG. 2) according to the exemplary embodiment of the present invention includes a voltage VscL supply unit 410, a voltage Vnf supply unit 420, and a selection circuit 430.

The voltage VscL supply unit 410 includes a diode D1, an anode of which is coupled to the scan electrode Y, and a transistor YscL, a drain of which is coupled to a cathode of the diode D1 and a source of which is coupled to a power source VscL supplying the voltage VscL.

The voltage Vnf supply unit 420 includes a diode D2, an anode of which is coupled to the scan electrode Y, and a transistor Ynf, a drain of which is coupled to a cathode of the diode D2 and a source of which is coupled to a power source Vnf supplying the voltage Vnf.

The selection circuit 430 includes a transistor Sch, a drain of which is coupled to a power source VscH supplying the voltage VscH and a source of which is coupled to the scan electrode Y, and a transistor Scl, a drain of which is coupled to the source of the transistor Sch and a source of which is coupled to the anodes of the diodes D1 and D2.

The voltage VscL supply unit 410 sequentially applies a scan voltage (the voltage VscL) to the plurality of scan electrodes Y of the plasma display panel 100 (for example, see FIG. 2). As described above, the voltage VscL supply unit 410 includes the diode D1, the anode of which is coupled to the scan electrode Y and the cathode of which is coupled to the drain of the transistor YscL. For this reason, even though the voltage of the scan electrode Y may become lower than the voltage VscL, a current does not flow through a reverse current path that is formed from the power source VscL to the scan electrode Y through the body diode of the transistor YscL.

The voltage Vnf supply unit 420 supplies the voltage Vnf that is the lowest voltage among the voltages to be applied to the scan electrode Y in the reset period. Here, the voltage Vnf is generated and supplied by the power supply 600 (for example, see FIG. 2). In general, the voltage VscL is set to be lower than the voltage Vnf. Accordingly, a current may flow through a reverse current path that is formed from the power source Vnf supplying the voltage Vnf to the scan electrode Y through the body diode of the transistor Ynf. In order to prevent (or hinder) a current from flowing through the reverse current path, the voltage Vnf supply unit 420 includes the diode D2, the anode of which is coupled to the scan electrode Y and the cathode of which is coupled to the drain of the transistor Ynf. Accordingly, a current does not flow through the reverse current path.

In the selection circuit 430, the two transistors Sch and Scl are selectively driven according to a control signal input from the control device 200 (for example, see FIG. 2), and the voltage VscH, the voltage VscL, and the voltage Vnf are selectively supplied to the scan electrode Y.

The voltage VscL supply unit 410 and the voltage Vnf supply unit 420 according to the current exemplary embodiment of the present invention include the diodes D1 and D2 for preventing (or hindering) the formation of a reverse current path in the respective supply units. Accordingly, an inflow of the reverse current does not occur, and thus levels of heat produced by the transistors YscL and Ynf can be suppressed to be not more than an acceptable level (e.g., a predetermined level).

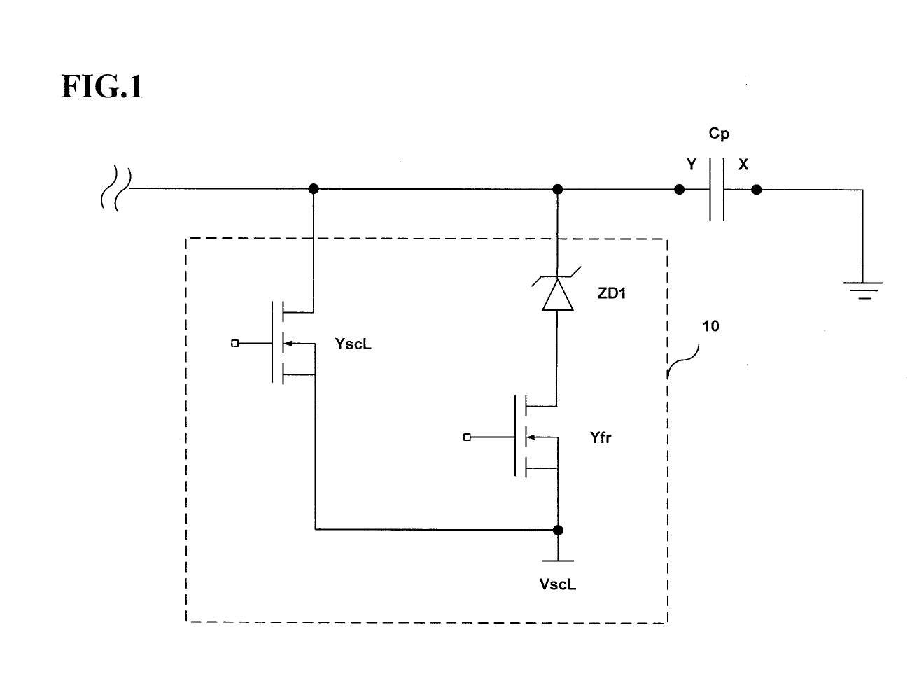

Further, the scan electrode driver 400 (for example, see FIG. 2) according to the current exemplary embodiment of the present invention does not use a Zener diode having a large withstand voltage, unlike the conventional driving apparatus 10 (for example, see FIG. 1). Therefore, the costs for implementing a plasma display device and power consumption can be reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

As described above, according to exemplary embodiments of the present invention, an inflow of a reverse current does not occur, and thus the level of heat produced by the transistor YscL and/or the transistor Ynf can be suppressed to be not more than a level (e.g., a predetermined level).

Further, since a Zener diode having a large withstand voltage is not used, the costs for implementing a plasma display device and power consumption can be reduced.

What is claimed is:

1. A plasma display device comprising:
a plasma display panel comprising a plurality of first electrodes, a plurality of second electrodes, and a plurality of third electrodes crossing the first and second electrodes;
a power supply for receiving an input voltage and generating a first voltage using the input voltage; and
a first driving unit for applying an output voltage to each of the first electrodes, wherein the output voltage falls gradually from a second voltage higher than the first voltage to the first voltage during a reset period,
wherein the first driving unit comprises:
a first diode having an anode coupled to each of the first electrodes; and
a first switch having a first terminal coupled to a cathode of the first diode and a second terminal coupled to a first power source for supplying the first voltage, and
wherein a voltage of each of the first electrodes falls to the first voltage when the first switch is in a turned-on state.

2. The plasma display device of claim 1,
wherein the power supply is adapted to generate a third voltage lower than the first voltage,
wherein the plasma display device further comprises a second driving unit, and
wherein the second driving unit comprises:
a second diode having an anode coupled to each of the first electrodes; and
a second switch having a first terminal coupled to a cathode of the second diode and a second terminal coupled to a second power source for supplying the third voltage.

3. The plasma display device of claim 2, wherein the third voltage corresponds to a scan voltage sequentially applied to the plurality of first electrodes during an address period.

4. The plasma display device of claim 3, wherein the first voltage is a lowest voltage applied to the first electrodes in the reset period.

5. A plasma display device comprising:
a plurality of first electrodes; and
a first driving unit for applying a scan voltage to each of the first electrodes in an address period,
wherein the first driving unit comprises:
a first diode having an anode coupled to each of the first electrodes; and
a first switch having a first terminal coupled to a cathode of the first diode and a second terminal coupled to a first power source for supplying the scan voltage, and
wherein the first diode is adapted to hinder a current flow from the first power source to each of the first electrodes.

6. The plasma display device of claim 5,
wherein the plasma display device further comprises a second driving unit, and
wherein the second driving unit comprises:
a second diode having an anode coupled to each of the first electrodes; and
a second switch having a first terminal coupled to a cathode of the second diode and a second terminal coupled to a second power source for supplying a second voltage, and
wherein the second voltage is higher than the scan voltage.

7. The plasma display device of claim 6, wherein the second driving circuit is adapted to gradually reduce a voltage of each of the first electrodes to the second voltage during a reset period.

8. The plasma display device of claim 7, wherein the second voltage is a lowest voltage applied to the first electrodes in the reset period.

9. A plasma display device comprising:
a plasma display panel comprising a plurality of first electrodes, a plurality of second electrodes, and a plurality of third electrodes crossing the first and second electrodes; and
an electrode driver,
wherein the electrode driver comprises:
a first diode having an anode coupled to each of the first electrodes;
a first switch having a first terminal coupled to a cathode of the first diode and a second terminal coupled to a first power source;
a second diode having an anode coupled to each of the first electrodes;
a second switch having a first terminal coupled to a cathode of the second diode and a second terminal coupled to a second power source; and
a selection circuit coupled between a third power source and the anodes of the first diode and the second diode.

10. The plasma display device of claim 1, wherein the selection circuit comprises:
a third switch having a first terminal coupled to the third power source and a second terminal coupled to one of the first electrodes; and
a fourth switch having a first terminal coupled to the one of the first electrodes and a second terminal coupled to the anodes of the first diode and the second diode.
